(19) United States
(12) Patent Application Publication
(10) Pub. No.: US 2024/0250244 A1
(43) Pub. Date: Jul. 25, 2024

(54) COMPOSITE SILICON-BASED NEGATIVE ELECTRODE MATERIAL, PREPARATION METHOD THEREFOR, NEGATIVE ELECTRODE SHEET COMPRISING SAME, AND LITHIUM-ION SECONDARY BATTERY

(71) Applicant: MURATA MANUFACTURING CO., LTD., Kyoto (JP)

(72) Inventors: Junjie GUO, Shanghai (CN); Li WANG, Shanghai (CN); Yan Zhou, Shanghai (CN); Yuli LI, Shanghai (CN); Kazumasa TAKESHI, Shanghai (CN)

(21) Appl. No.: 18/411,438

(22) Filed: Jan. 12, 2024

(30) Foreign Application Priority Data
Jan. 19, 2023 (CN) 202310097673.2

(51) Int. Cl. H01M 4/36; H01M 4/38; H01M 4/46; H01M 4/48; H01M 10/0525

(52) U.S. Cl. CPC H01M 4/366; H01M 4/38; H01M 4/386; H01M 4/463; H01M 4/483; H01M 10/0525; H01M 2004/027

(57) ABSTRACT

A composite silicon-based negative electrode material, a preparation method therefor, a negative electrode sheet comprising same, and a lithium-ion secondary battery are provided. The composite silicon-based negative electrode material comprises a silicon-based material core layer and a metal material shell layer, wherein the metal material shell layer coats the silicon-based material core layer, and the silicon-based material core layer comprises a permeation area formed by the permeation of the metal material shell layer into the silicon-based material core layer. By means of the composite silicon-based negative electrode material and the preparation method therefor of the present application, the conductivity of the negative electrode material is improved, the expansion rate of the core layer formed by the silicon-based material is limited, and the consumption of lithium ions caused by a reaction between an electrolyte and the surface of the silicon-based material is effectively reduced. Therefore, the first-time coulombic efficiency and cycle performance of the lithium-ion secondary battery formed from the composite silicon-based negative electrode material of the present application are improved.

This application claims the benefit of Chinese Patent Application No. 202310097673.2, filed on Jan. 19, 2023, and titled “Composite silicon-based negative electrode material, preparation method therefor, negative electrode sheet comprising same, and lithium-ion secondary battery”, the entire contents of which are incorporated by reference herein.

### TECHNICAL FIELD

The present application relates to the field of lithium-ion secondary batteries, and in particular, to a composite silicon-based negative electrode material, a preparation method therefor, a negative electrode sheet comprising same, and a lithium-ion secondary battery.

### BACKGROUND

In recent years, with the continuous update of electronic technologies, the demand for a battery device for supporting the energy supply of an electronic device is also increasing. Today, batteries capable of storing more charge and outputting a high power are needed. Conventional lead-acid batteries, nickel-hydrogen batteries, and the like have been unable to meet the needs of new electronic products such as mobile devices such as smartphones and fixed devices such as electrical storage systems. Therefore, lithium batteries have attracted wide attention. In the development of lithium batteries, the capacity and properties thereof have been improved effectively. Lithium-ion batteries have advantages such as a high energy density, a high working voltage, a long cycle life, and low environmental pollution, and thus have become a new green high-energy chemical power supply with extremely potential development in the current world. Electrolyte is an important component of a lithium-ion battery, and has important influences on many properties of the battery, such as voltage, energy density, power, service life, applicable range of temperature, and safety performance.

Currently, lithium-ion batteries have been widely used in fields such as information appliances (3C consumer electronics), new energy automobiles, and energy storage. Along with this comes growing demand for battery performance. At present, graphite, which is a main negative electrode material, has excellent cycle performance, but its theoretical specific capacity (372 mAh/g) is low. Therefore, a high specific capacity negative electrode material is a hot topic of current research and development.

Silicon has a theoretical specific capacity of 4200 mAh/g, which is much higher than that of graphite, and thus is considered to be one of the new negative electrode materials most likely to replace graphite. However, silicon itself has a low conductivity and cannot be directly used as a negative electrode material. In addition, large volume change of silicon generally occurs during charging and discharging, for example, the volume increases to 300% of the original volume, so that problems such as pulverization of materials and structural collapse are easily caused, and finally, an electrode active material is detached from a current collector, and then the cycle performance is deteriorated. Another typical silicon-based material is referred to as silicon monoxide, and it is generally considered that fine Si particles are uniformly dispersed in a SiO₂ structure. As SiO₂ can buffer the expansion of the Si particles, the maximum volume change rate of silicon monoxide during charging and discharging can be reduced to 200% (reduced from 300%) of the original volume of the material. Further, the intrinsic conductivity of silicon monoxide is likewise low. Therefore, silicon monoxide still cannot meet the requirements of the cycle performance of the lithium-ion secondary battery.

Therefore, in order to solve the problems mentioned above, there is still a need to develop a negative electrode material capable of increasing the conductivity of the negative electrode material and effectively improving the cycle characteristics of a lithium-ion secondary battery.

### SUMMARY

The main object of the present application is to provide a composite silicon-based negative electrode material, a preparation method therefor, a negative electrode sheet comprising same, and a lithium-ion secondary battery, so as to solve the problems in the prior art that the conductivity of a negative electrode material is low and the requirements for the cycle performance of a lithium-ion secondary battery cannot be satisfied.

In order to achieve the described object, according to one aspect of the present application, provided is a composite silicon-based negative electrode material, comprising: a silicon-based material core layer; and a metal material shell layer coating the silicon-based material core layer, wherein the silicon-based material core layer comprises a permeation area formed by the permeation of the metal material shell layer into the silicon-based material core layer.

Further, in the described composite silicon-based negative electrode material, the thickness of the silicon-based material core layer is in the range of about 10 nm to about 10000 nm.

Further, in the described composite silicon-based negative electrode material, the thickness of the metal material shell layer is in the range of about 5 nm to about 1000 nm.

Further, in the described composite silicon-based negative electrode material, the thickness of the permeation area is in the range of about 5 nm to about 100 nm.

Further, in the described composite silicon-based negative electrode material, the silicon-based material core layer comprises elemental silicon, a silicon-oxygen compound, a silicon-carbon compound, a silicon-aluminium alloy, a silicon-titanium alloy, or any combination thereof.

Further, in the described composite silicon-based negative electrode material, the metal material shell layer comprises aluminum and/or titanium.

Further, in the described composite silicon-based negative electrode material, the amount of the silicon-based material core layer is in the range of about 85 wt % to about 99.5 wt %, and the amount of the metal material shell layer is in the range of about 0.5 wt % to about 15 wt %, based on the total weight of the composite silicon-based negative electrode material.

According to another aspect of the present application, provided is a method for preparing a composite silicon-based negative electrode material, comprising: step S1, placing a silicon-based material precursor and a metal material precursor in a reactor at a mass ratio of 0.2:1 to 20:1; and step S2, maintaining the temperature at about 500° C. to about 700° C. for about 10 minutes to about 2 hours in an inert atmosphere.

Further, the method further comprises: step S3, sieving the product obtained in step S2 to obtain a composite silicon-based negative electrode material with a median particle diameter ranging from about 0.5 μm to about 20 μm.

Further, in the described method, the metal material precursor comprises titanium, aluminum, a chloride of titanium, a chloride of aluminum, or any combination thereof.

Further, in the described method, the silicon-based material precursor comprises elemental silicon, a silicon-oxygen compound, a silicon-carbon compound, a silicon-aluminum alloy, a silicon-titanium alloy, or any combination thereof.

Further, in the described method, the reactor comprises a rotary kiln or a fluidized bed; and preferably, the rotation speed of the fluidized bed is between about 0.5 rpm and about 20 rpm.

Further, in the described method, the inert atmosphere comprises argon, helium, nitrogen, or any combination thereof.

According to still another aspect of the present application, provided is a negative electrode sheet for a lithium-ion secondary battery, comprising the composite silicon-based negative electrode material of the present application.

According to yet another aspect of the present application, provided is a lithium-ion secondary battery, comprising: a positive electrode sheet, a negative electrode sheet, and a separator, wherein the negative electrode sheet comprises the composite silicon-based negative electrode material of the present application.

By means of the composite silicon-based negative electrode material and the preparation method therefor of the present application, the conductivity of the negative electrode material is improved, furthermore, the expansion rate of the core layer formed by the silicon-based material is limited, and the consumption of lithium ions caused by a reaction between an electrolyte and the surface of the silicon-based material is effectively reduced. Therefore, the first-time coulombic efficiency and cycle performance of a lithium-ion secondary battery formed from the composite silicon-based negative electrode material of the present application are improved.

### DETAILED DESCRIPTION OF THE EMBODIMENTS

It is important to note that the examples of the present application and the characteristics in the examples can be combined under the condition of no conflicts. Hereinafter, the present application will be described in detail with reference to examples. The following examples are merely exemplary, and do not limit the scope of protection of the present application.

As explained in the background art, in the prior art, silicon or silicon monoxide is generally used as the negative electrode material. However, as the conductivity of silicon or silicon monoxide is low and volume of silicon or silicon monoxide expands unfavorably during charging and discharging, it is still necessary to further improve the negative electrode material. In view of the problems in the prior art, according to a typical embodiment of the present application, provided is a composite silicon-based negative electrode material, comprising: a silicon-based material core layer; and a metal material shell layer coating the silicon-based material core layer, wherein the silicon-based material core layer comprises a permeation area formed by the permeation of the metal material shell layer into the silicon-based material core layer.

Unlike the prior art in which only silicon or silicon monoxide is used as the negative electrode material, the composite silicon-based negative electrode material of the present application comprises a silicon-based material core layer and a metal material shell layer. The metal material shell layer permeates into the silicon-based material core layer, thereby forming a permeation area simultaneously containing the silicon-based material and the metal material, and the permeation area is located in the silicon-based material core layer. The composite silica-based composite material thus formed exhibits excellent conductivity in the case of comprising the metal material shell layer and the permeation area. In addition, due to the presence of the metal material shell layer, the expansion rate of the silicon-based material core layer is effectively limited, thereby increasing the first-time Coulomb efficiency and the cycle retention rate of a lithium-ion secondary battery prepared thereby.

In conclusion, the composite silicon-based negative electrode material of the present application has a nanoalloy layer (a permeation area) formed by diffusion of a passive metal (a metal material shell layer) and a silicon-based material (a silicon-based material core layer) and a surface passive metal layer. Both the nanoalloy layer and the passive metal layer have excellent conductivity. The nanoalloy layer is contained in the silicon-based material, and the passive metal layer is uniformly distributed on the surface of the silicon-based material. Thus, a continuous conductive network is easily formed, and the conductivity of the silicon-based material is greatly improved. The passive metal layer located on the surface of the composite silicon-based negative electrode material also has a high tensile strength, can effectively inhibit the volume expansion of the silicon-based material, and can inhibit the pulverization, shedding and deterioration of the cycle performance of the silicon-based material. The chemical stability of the passive metal layer is extremely high, and the consumption of lithium ions caused by a reaction between an electrolyte and the surface of the silicon-based material can be effectively reduced, thereby improving the first-time Coulombic efficiency and cycle performance of a lithium-ion secondary battery formed by the composite silicon-based negative electrode material of the present application. The nanoalloy layer enables the silicon-based material and the passive metal layer to form metallurgical bonds, and such strong bonding force can ensure that the composite silicon-based negative electrode material has strong structural stability and cycle stability.

In some embodiments of the present application, the silicon-based material core layer has a thickness in the range of about 10 nm to about 10000 nm. Within the thickness range above, the silicon-based material core layer can effectively maintain the capacity of the battery within a desired range. If the thickness of the silicon-based material core layer is less than 10 nm, the capacity of the battery will be too low, and if the thickness of the silicon-based material core layer is greater than 10000 nm, the volume expansion effect will disadvantageously increase during the cycling process of the battery, thereby reducing the cycle performance of the battery.

In some embodiments of the present application, for different examples, the thickness of the silicon-based material core layer may be in the following range: about 10 nm-about 10000 nm, about 50 nm-about 10000 nm, about 100 nm-about 10000 nm, about 200 nm-about 10000 nm, about 300 nm-about 10000 nm, about 400 nm-about 10000 nm, about 500 nm-about 10000 nm, about 1000 nm-about 10000 nm, about 2000 nm-about 10000 nm, about 3000 nm-about 10000 nm, about 4000 nm-about 10000 nm, about 5000 nm-about 10000 nm, about 10 nm-about 9000 nm, about 10 nm-about 8000 nm, about 10 nm-about 7000 nm, about 10 nm-about 6000 nm, about 10 nm-about 5000 nm, about 10 nm-about 1000 nm, about 10 nm-about 500 nm, or about 10 nm-about 100 nm.

In some embodiments of the present application, the thickness of the metal material shell layer is in the range of about 5 nm to about 1000 nm, and preferably, the thickness of the metal material shell layer is in the range of about 30 nm to about 300 nm. When the thickness of the metal material shell layer is less than 5 nm, the metal material is not sufficient to fully coat the core layer inside, thereby causing inevitable expansion of the core layer in charging and discharging cycles of the lithium-ion secondary battery, and causing problems such as pulverization and structural collapse of the material. When the thickness of the metal material shell layer is greater than 1000 nm, insertion and deintercalation of lithium ions on the negative electrode material are affected due to the metal material being excessively thick.

In some embodiments of the present application, for different examples, the lower limit of the thickness of the metal material shell layer may be about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, or about 30 nm, and the upper limit thereof may be about 1000 nm, about 950 nm, about 900 nm, about 850 nm, about 800 nm, about 750 nm, about 700 nm, about 650 nm, about 600 nm, about 550 nm, about 500 nm, about 450 nm, about 400 nm, about 350 nm, or about 300 nm.

In particular, the thickness of the metal material shell layer may be in the range of about 5 nm-about 1000 nm, about 10 nm-about 950 nm, about 15 nm-about 900 nm, about 20 nm-about 850 nm, about 25 nm-about 800 nm, about 30 nm-about 750 nm, about 30 nm-about 700 nm, about 30 nm-about 650 nm, about 30 nm-about 600 nm, about 30 nm-about 550 nm, about 30 nm-about 500 nm, about 30 nm-about 450 nm, about 30 nm-about 400 nm, about 30 nm-about 350 nm, or about 30 nm-about 300 nm.

In some embodiments of the application, the thickness of the permeation area is in the range of about 5 nm to about 100 nm; and preferably, the thickness of the permeation area is in the range of about 10 nm to about 50 nm. When the thickness of the permeation area is less than 5 nm, as the permeation area between the metal material shell layer and the silicon-based material core layer is too small, delamination may occur during charging and discharging of the lithium-ion secondary battery, and the conductivity of the negative electrode material is also disadvantageously reduced. When the thickness of the permeation area is greater than 100 nm, the delithiation capacity of the negative electrode material may be adversely affected.

In some embodiments of the application, for different examples, the lower limit of the thickness of the permeation area may be about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, or about 30 nm, and the upper limit thereof may be about 100 nm, about 95 nm, about 90 nm, about 85 nm, about 80 nm, about 75 nm, about 70 nm, about 65 nm, about 60 nm, about 55 nm, about 50 nm, about 45 nm, about 40 nm, about 35 nm, or about 30 nm.

Specifically, the thickness of the permeation area may be in the range of about 5 nm-100 nm, about 6 nm-about 100 nm, about 7 nm-about 100 nm, about 8 nm-about 100 nm, about 9 nm-about 100 nm, about 10 nm-about 100 nm, about 11 nm-about 100 nm, about 12 nm-about 100 nm, about 13 nm-about 100 nm, about 14 nm-about 100 nm, about 15 nm-about 100 nm, about 16 nm-about 100 nm, about 17 nm-about 100 nm, about 18 nm-about 100 nm, about 19 nm-about 100 nm, about 20 nm-about 100 nm, about 5 nm-about 90 nm, about 5 nm-about 80 nm, about 5 nm-about 70 nm, about 5 nm-about 60 nm, about 5 nm-about 50 nm, about 5 nm-about 40 nm, about 5 nm-about 30 nm, about 6 nm-about 30 nm, about 7 nm-about 30 nm, about 8 nm-about 30 nm, about 9 nm-about 30 nm, or about 10 nm-about 30 nm.

In some embodiments of the application, the silicon-based material core layer comprises elemental silicon, a silicon-oxygen compound, a silicon-carbon compound, a silicon-aluminum alloy, a silicon-titanium alloy, or any combination thereof. In the case of using the described materials, the metal material contained in the metal material shell layer can better permeate into the silicon-based material core layer to form a permeation area, thereby realizing a good coating effect and excellent conductivity and delithiation capacity.

In some embodiments of the application, the metal material shell layer comprises aluminum and/or titanium. As both aluminum and titanium have excellent conductivity and ductility, in the case of coating the silicon-based material core layer with aluminum and/or titanium, it is possible to coat the core layer uniformly and densely and to impart good conductivity to the coating material.

In some embodiments of the application, the silicon-based material core layer is present in an amount ranging from about 85 wt % to about 99.5 wt %, and the metal material shell layer is present in an amount ranging from about 0.5 wt % to about 15 wt %, based on the total weight of the composite silicon-based negative electrode material. In some embodiments, for different examples, the amount of the silicon-based material core layer is in the range of about 85 wt %-about 88 wt %, 85 wt %-about 89 wt %, about 85 wt %-about 90 wt %, about 85 wt %-about 91 wt %, about 85 wt %-about 92 wt %, about 85 wt %-about 93 wt %, about 85 wt %-about 94 wt %, about 85 wt %-about 95 wt %, about 85 wt %-about 96 wt %, about 85 wt %-about 97 wt %, about 85 wt %-about 98 wt %, about 85 wt %-about 99 wt %, about 85 wt %-about 99.5 wt %, about 86 wt %-about 99.5 wt %, about 87 wt %-about 99.5 wt %, about 88 wt %-about 99.5 wt %, about 89 wt %-about 99.5 wt %, about 90 wt %-about 99.5 wt %, about 91 wt %-about 99.5 wt %, about 92 wt %-about 99.5 wt %, about 93 wt %-about 99.5 wt %, about 94 wt %-about 99.5 wt %, or about 95 wt %-about 99.5 wt %, based on the total weight of the composite silicon-based negative electrode material. In other embodiments, for different examples, the amount of the metal material shell layer is in the range of about 0.5 wt %-about 15 wt %, about 1 wt %-about 15 wt %, about 2 wt %-about 15 wt %, about 3 wt %-about 15 wt %, about 4 wt %-about 15 wt %, about 5 wt %-about 15 wt %, about 6 wt %-about 15 wt %, about 7 wt %-about 15 wt %, about 8 wt %-about 15 wt %, about 9 wt %-about 15 wt %, about 10 wt %-about 15 wt %, about 0.5 wt %-about 14 wt %, about 0.5 wt %-about 13 wt %, about 0.5 wt %-about 12 wt %, about 0.5 wt %-about 11 wt %, about 0.5 wt %-about 10 wt %, about 0.5 wt %-about 9 wt %, about 0.5 wt %-about 8 wt %, about 0.5 wt %-about 7 wt %, about 0.5 wt %-about 6 wt %, or about 0.5 wt %-about 5 wt %, based on the total weight of the composite silicon-based negative electrode material.

According to another typical embodiment of the present application, provided is a method for preparing a composite silicon-based negative electrode material. The method comprises: step S1, placing a silicon-based material precursor and a metal material precursor in a reactor at a mass ratio of 0.2:1 to 20:1; and step S2, maintaining the temperature at about 500° C. to about 700° C. for about 10 minutes to about 2 hours in an inert atmosphere.

In an embodiment of preparing a composite silicon-based negative electrode material by using the method of the present application, a method comprising mixing a silicon-based material precursor and a metal material precursor at a certain ratio, then performing a reaction in a thermostatic reactor, so that a passive metal substance generated by the reaction of the metal precursor material completely coats the silicon-based material, and as the metal material permeates into the silicon-based material, a permeation area resulting from doping of the passive metal substance with the silicon-based material is generated. Compared with the prior art in which a metal powder and a silicon-based material powder are ball-milled and mixed at a temperature of 1000° C. or higher to form a coating material, the method of the present application uses milder reaction conditions, thereby avoiding disproportionation and deterioration of the silicon-based material due to an excessively high temperature, and further increasing the cycle performance of the lithium-ion secondary battery formed thereby. In addition, when a ball milling method in the prior art is used, the metal material and the silicon-based material cannot be mixed and permeated on a microscopic scale, and the metal material is simply attached to the surface of the silicon-based material. By means of the method of the present application, the metal material can be more uniformly and completely coated on the silicon-based material, and is permeated into the silicon-based material to form a permeation area, thereby increasing the conductivity and cycle performance of the composite silicon-based negative electrode material.

In conclusion, the method for preparing a composite silicon-based negative electrode material of the present application can effectively suppress the degradation of the silicon-based material due to a low maintaining temperature. In addition, a gas phase compound is generated in the heat maintaining process, so that a metal generated by a reaction forms a shell layer of a passive metal on the surface of the silicon-based material under the effect of chemical vapor deposition, thereby implementing uniform coating of the passive metal on the surface of the silicon-based material, and effectively improving the conductivity and cycle performance of the material. In the present application, a passive metal can be directly combined by means of chemical vapor deposition, and the thickness of a nanoalloy layer (a permeation area) and a passive metal shell layer can be easily adjusted by controlling the feed ratio, the temperature and the time during maintaining the temperature, thereby facilitating industrial production.

In some embodiments of the present application, the weight ratio of the silicon-based material precursor to the metal material precursor is in the range of 0.2:1 and 20:1. For different examples, the lower limit of the weight ratio of the silicon-based material precursor to the metal material precursor can be 0.2:1, 0.3:1, 0.4:1, 0.5:1, 0.6:1, 0.7:1, 0.8:1, 0.9:1, 1:1, 2:1, 3:1, 4:1, 5:1, 6:1, 7:1, 8:1, 9:1, or 10:1, and the upper limit can be 20:1, 19:1, 18:1, 17:1, 16:1, 15:1, 14:1, 13:1, 12:1, 11:1, or 10:1.

In particular, the weight ratio of the silicon-based material precursor to the metal material precursor may be in the range of 0.2:1-20:1, 0.3:1-20:1, 0.4:1-20:1, 0.5:1-20:1, 0.6:1-20:1, 0.7:1-20:1, 0.8:1-20:1, 0.9:1-20:1, 1:1-20:1, 2:1-20:1, 3:1-20:1, 4:1-20:1, 5:1-20:1, 6:1-20:1, 7:1-20:1, 8:1-20:1, 9:1-20:1, 10:1-20:1, 0.2:1-19:1, 0.2:1-18:1, 0.2:1-17:1, 0.2:1-16:1, 0.2:1-15:1, 0.2:1-14:1, 0.2:1-13:1, 0.2:1-12:1, 0.2:1-11:1, or 0.2:1-10:1.

In other embodiments, the silicon-based material precursor and the metal material precursor may be maintained at a temperature of about 500° C. to about 700° C. for about 10 minutes to about 2 hours. In particular examples, the heat maintaining temperature may be about 500° C., about 530° C., about 550° C., about 580° C., about 600° C., about 630° C., about 650° C., about 680° C., or about 700° C. When the heat maintaining temperature is less than 500° C., the metal material precursor cannot efficiently react to form a passive metal coating the silicon-based material, and cannot efficiently permeate into the silicon-based material either. When the heat maintaining temperature is higher than 700° C., the silicon-based material may be disproportionately deteriorated, thereby deteriorating the cycle performance of the lithium-ion secondary battery thus formed. In other embodiments, the heat maintaining time may be in the range of about 10 minutes to about 2 hours, and may be, for example, about 10 minutes, about 20 minutes, about 30 minutes, about 40 minutes, about 50 minutes, about 1 hour, about 1.5 hours, or about 2 hours.

In a further embodiment, the method for producing a composite silicon-based negative electrode material of the present application further includes step S3, sieving the product obtained in the step S2 to obtain a composite silicon-based negative electrode material with a median particle diameter ranging from about 0.5 μm to about 20 μm. After sieving, the size of the obtained composite silicon-based material is more suitable for preparing an negative electrode for a lithium-ion secondary battery. In some examples, the sieved composite silicon-based negative electrode material may have a median particle diameter in the range of about 0.5 μm to about 20 μm, for example in the range of about 0.5 μm-about 20 μm, about 0.6 μm-about 20 μm, about 0.7 μm-about 20 μm, about 0.8 μm-about 20 μm, about 0.9 μm-about 20 μm, about 1 μm-about 20 μm, about 2 μm-about 20 μm, about 3 μm-about 20 μm, about 4 μm-about 20 μm, about 5 μm-about 20 μm, about 6 μm-about 20 μm, about 7 μm-about 20 μm, about 8 μm-about 20 μm, about 9 μm-about 20 μm, about 10 μm-about 20 μm, about 0.5 μm-about 19 μm, about 0.5 μm-about 18 μm, about 0.5 μm-about 17 μm, about 0.5 μm-about 16 μm, about 0.5 μm-about 15 μm, about 0.5 μm-about 14 μm, about 0.5 μm-about 13 μm, about 0.5 μm-about 12 μm, about 0.5 μm-about 11 μm, or about 0.5 μm-about 10 μm.

In some embodiments, the metal material precursor used in step S1 of the method for preparing a composite silicon-based negative electrode material comprises titanium, aluminum, a chloride of titanium, a chloride of aluminum, or any combination thereof. In particular examples, the metal material precursor may comprise elemental titanium, elemental aluminum, titanium monochloride, titanium dichloride, titanium trichloride, titanium tetrachloride, aluminum monochloride, aluminum dichloride, aluminum trichloride, aluminum tetrachloride, or any combination thereof.

In some embodiments, the silicon-based material precursor used in step S1 of the method for preparing a composite silicon-based negative electrode material comprises elemental silicon, a silicon-oxygen compound, a silicon-carbon compound, a silicon-aluminum alloy, a silicon-titanium alloy, or any combination thereof.

In some embodiments, the reactor in step S1 may comprise a rotary kiln or a fluidized bed. In a further example, the reactor is a fluidized bed reactor, and the rotational speed of the fluidized bed is in the range of about 0.5 to about 20 rpm. In some specific embodiments, the rotation speed of the fluidized bed can be in the range of about 0.5 rpm-about 20 rpm, about 0.6 rpm-about 20 rpm, about 0.7 rpm-about 20 rpm, about 0.8 rpm-about 20 rpm, about 0.9 rpm-about 20 rpm, about 1 rpm-about 20 rpm, about 2 rpm-about 20 rpm, about 3 rpm-about 20 rpm, about 4 rpm-about 20 rpm, about 5 rpm-about 20 rpm, about 6 rpm-about 20 rpm, about 7 rpm-about 20 rpm, about 8 rpm-about 20 rpm, about 9 rpm-about 20 rpm, about 10 rpm-about 20 rpm, about 0.5 rpm-about 19 rpm, about 0.5 rpm-about 18 rpm, about 0.5 rpm-about 17 rpm, about 0.5 rpm-about 16 rpm, about 0.5 rpm-about 15 rpm, about 0.5 rpm-about 14 rpm, about 0.5 rpm-about 13 rpm, about 0.5 rpm-about 12 rpm, about 0.5 rpm-about 11 rpm, or about 0.5 rpm-about 10 rpm.

In other embodiments, step S2 of the method for producing a composite silicon-based negative electrode material of the present application may be carried out in an inert atmosphere, and the inert atmosphere that may be used includes, but is not limited to, argon, helium, nitrogen, or any combination thereof.

According to another typical embodiment of the present application, provided is a negative electrode sheet for a lithium-ion secondary battery, which comprises the composite silicon-based negative electrode material of the present application. Due to the inclusion of the composite silicon-based negative electrode material of the present application, the negative electrode sheet for a lithium-ion secondary battery of the present application has excellent conductivity and a reduced expansion rate. Further, excellent cycle performance can be maintained even after a plurality of charge/discharge cycles.

According to another typical embodiment of the present application, provided is a lithium-ion secondary battery, comprising: a positive electrode sheet, a negative electrode sheet, and a separator, wherein the negative electrode sheet comprises the composite silicon-based negative electrode material of the present application. In the case of comprising the composite silicon-based negative electrode material of the present application, the lithium-ion secondary battery of the present application exhibits excellent first-time coulombic efficiency and cycle retention rate.

The present application will be further described in detail with reference to the following examples, which should not be construed as limiting the scope of protection of the present application.

### Example 1

### Preparation of a Composite Silicon-Based Negative Electrode Material

4000 g of TiCl₂ and 800 g of Si element were placed in a fluidized bed reactor, wherein the mass ratio of Si element to TiCl₂ was 0.2:1. The reactor was filled with helium gas, and then the reaction was maintained at a temperature of 700° C. for 15 minutes, so as to obtain a crude composite silicon-based negative electrode material, wherein the converter speed of the fluidized bed reactor is 10 rmp. The crude composite silicon-based negative electrode material was sieved to obtain a finished composite silicon-based negative electrode material with a median particle size of 20 μm.

### Preparation of a Lithium-Ion Secondary Battery

### Preparation of a Positive Electrode

92.0 g of positive electrode active material lithium iron phosphate (LFP), 5.0 g of a graphite conductive agent, and 3.0 g of a polyvinylidene fluoride binder were mixed to obtain a positive electrode mixture, and the obtained positive electrode mixture was dispersed in 33.0 g of N-methylpyrrolidone to obtain a positive electrode mixture slurry. Subsequently, the positive mixture slurry was coated on an aluminum foil to obtain a positive electrode current collector. The positive electrode current collector was dried, and a positive electrode sheet was formed by a stamping forming process.

### Preparation of a Negative Electrode

97.0 g of the composite silicon-based negative electrode material, 2.0 g of styrene-butadiene rubber, and 1.0 g of carboxymethyl cellulose were added to an appropriate amount of water and stirred to form a negative electrode slurry which can be used for coating. Then, the obtained negative electrode slurry was uniformly coated on a copper foil to obtain a negative electrode current collector. The negative electrode current collector was dried, and a negative electrode sheet was formed by a stamping forming process.

### Preparation of an Electrolyte

15.0 g of ethylene carbonate, 70.0 g of dimethyl carbonate, and 15.0 g of lithium hexafluorophosphate were mixed to prepare an electrolyte.

### Assembly of a Battery

A CR2016 button battery was assembled in a dry laboratory. The positive electrode sheet prepared in the foregoing step is used as the positive electrode, and the negative electrode sheet prepared in the foregoing step is used as the negative electrode. The positive electrode, the negative electrode, the separator, and a battery shell of the button battery were assembled, and the electrolyte was injected. After the battery was assembled, the battery was allowed to stand for about 24 h for aging, so as to obtain a lithium cobalt nickel manganate button battery.

### Examples 2-15

Composite silicon-based negative electrode materials and lithium-ion secondary batteries were prepared in the same manner as in Example 1, and the differences are shown in the following Table 1:

TABLE 1

| | | | | | Weight | | | | | |
|---|---|---|---|---|---|---|---|---|---|---|
| | | | | | ratio of | | | | | |
| | | | | | silicon- | | | | | |
| | | | | | based | | | | | |
| | Metal | Metal | Silicon- | Silicon | material | | | Temperature | | Particle |
| | material | material | based | based | to metal | | Maintained | maintaining | Converter | diameter |
| | precursor | precursor | material | material | material | Inert | temperature, | time, | speed, | after |
| Example | type | weight, g | type | weight, g | precursor | atmosphere | ° C. | min | RMP | sieving |
| 1 | TiCl₂ | 40 | Si | 8 | 0.2:1 | Helium | 700 | 15 | 10 | 20 |
| 2 | Al | 6.8 | SiO | 8 | 0.2:1 | Argon | 700 | | 10 | 11 |
| | AlCl₃ | 33.2 | | | | | | 90 | | |
| 3 | TiCl₃ | 8 | SiO | 8 | 1:1 | Argon | 600 | 15 | 20 | 5 |
| 4 | Al | 0.3 | SiO | 8 | 5:1 | Helium | 550 | 15 | 15 | |
| | AlCl₃ | 1.3 | | | | | | | | 10 |
| 5 | TiCl₂ | 0.8 | Si | 8 | 10:1 | Helium | 500 | 15 | 5 | 5 |
| 6 | Al | 0.2 | Si | 8 | 10:1 | Helium | 700 | 30 | 10 | 3 |
| | AlCl₃ | 0.6 | | | | | | | | |
| 7 | TiCl₂ | 0.6 | Si | 8 | 5:1 | Nitrogen | 650 | 45 | 5 | 4.5 |
| | TiCl₃ | 1.0 | | | | | | | | |
| 8 | AlCl | 0.3 | Si | 8 | 5:1 | Nitrogen | 600 | 30 | 1 | 7 |
| | AlCl₂ | 0.5 | | | | | | | | |
| | AlCl₃ | 0.8 | | | | | | | | |
| 9 | TICl | 0.1 | Si | 8 | 20:1 | Helium | 550 | 120 | 5 | 5 |
| | TiCl₂ | 0.1 | | | | | | | | |
| | TiCl₃ | 0.1 | | | | | | | | |
| | TiCl₄ | 0.1 | | | | | | | | |
| 10 | AlCl | 0.1 | Si | 8 | 16:1 | Helium | 500 | 40 | 0.5 | 10 |
| | AlCl₃ | 0.1 | | | | | | | | |
| | Al | 0.3 | | | | | | | | |
| 11 | TiCl₂ | 0.2 | Si | 8 | 10:1 | Helium | 700 | 35 | 1 | 5 |
| | TiCl₃ | 0.3 | | | | | | | | |
| | TiCl₄ | 0.2 | | | | | | | | |
| | Ti | 0.1 | | | | | | | | |
| 12 | TICl | 0.3 | Si | 8 | 5:1 | Argon | 650 | 30 | 0.2 | 5 |
| | TiCl₂ | 0.4 | | | | | | | | |
| | TiCl₃ | 0.4 | | | | | | | | |
| | TiCl₄ | 0.3 | | | | | | | | |
| | Ti | 0.2 | | | | | | | | |
| 13 | TiCl₃ | 4 | Si | 8 | 2:1 | Argon | 600 | 10 | 0.2 | 4 |
| 14 | Al | 2.5 | Si | 8 | 1:1 | Helium | 550 | 20 | 5 | 2 |
| | AlCl₃ | 5.5 | | | | | | | | |
| 15 | TiCl₃ | 16 | Si | 8 | 0.5:1 | Nitrogen | 500 | 20 | 5 | 1 |

### Comparative Examples 1-4

Composite silicon-based negative electrode materials and lithium-ion secondary batteries were prepared in the same manner as in Example 1, and the differences are shown in the following Table 2:

TABLE 2

| | | | | | Weight | | | | | |
|---|---|---|---|---|---|---|---|---|---|---|
| | | | | | ratio of | | | | | |
| | | | | | silicon- | | | | | |
| | | | | | based | | | | | |
| | Metal | Metal | Silicon- | Silicon- | material | | | Temperature | | Particle |
| | material | material | based | based | to metal | | Maintained | maintaining | Converter | diameter |
| Comparative | precursor | precursor | material | material | material | Inert | temperature, | time, | speed, | after |
| Examples | type | weight, g | type | weight, g | precursor | atmosphere | ° C. | min | rmp | sieving |
| 1 | TiCl₃ | 4 | Si | 8 | 2:1 | Helium | 800 | 130 | 10 | 5 |
| 2 | AlCl₃ | 8 | Si | 8 | 1:1 | Argon | 800 | 150 | 10 | 5 |
| 3 | TiCl₃ | 0.32 | Si | 8 | 25:1 | Argon | 700 | 8 | 10 | 3 |
| 4 | AlCl₃ | 0.6 | Si | 8 | 13.3:1 | Helium | 700 | 5 | 10 | 3 |

### Comparative Example 5

### Preparation of a Composite Silicon-Based Negative Electrode Material

8 g of titanium powder was added to a ball mill together with 8 g of SiO for ball milling for 7 hours. After ball milling, the resultant was put into a thermal insulation chamber and maintained at a temperature of 1000° C. for 6 hours. Polyvinyl alcohol was added to the product obtained after the thermal insulation to prepare a slurry, in which the addition amount (weight) of the polyvinyl alcohol is 5% of the silicon-based composite material obtained after the thermal insulation.

### Preparation of a Lithium-Ion Secondary Battery

A lithium-ion secondary battery was prepared in the same manner as in Example 1.

### Physical Property Test of the Composite Silicon-Based Negative Electrode Material

The metal layer content of the composite silicon-based negative electrode material prepared in Examples 1-15 and Comparative Examples 1-5 of the present application was examined using an ICP spectrometer (iCAP 7600).

A sample slice of the composite silicon-based negative electrode material prepared in Examples 1-15 and Comparative Examples 1-5 of the present application was observed using a field emission scanning electron microscope (FE-SEM), and the thickness of the silicon-based material, the thickness of the metal layer and the thickness of the permeation area (the nanoalloy layer) were measured.

The measurement results are shown in Table 3 below:

TABLE 3

| | | | | | | | Permeation |
|---|---|---|---|---|---|---|---|
| | | | Silicon- | | | | area |
| | Silicon- | | based | | | Metal | (nanoalloy |
| | based | Silicon- | material | Metal | Metal | layer | layer) |
| | material | based | thickness, | layer | layer | thickness, | thickness, |
| | content | material | nm | content | material | nm | nm |
| Example 1 | 85.0% | Si | 100 | 15.0% | Ti | 110 | 60 |
| Example 2 | 88.0% | SiO | 10000 | 12.0% | Al | 1000 | 100 |
| Example 3 | 90.0% | SiO | 5000 | 10.0% | Ti | 40 | 12 |
| Example 4 | 95.0% | SiO | 5000 | 5.0% | Al | 9 | 6 |
| Example 5 | 99.0% | Si | 100 | 1.0% | Ti | 5 | 5 |
| Example 6 | 99.5% | Si | 100 | 0.5% | Al | 10 | 7 |
| Example 7 | 94.5% | Si | 100 | 5.5% | Ti | 30 | 30 |
| Example 8 | 95.5% | Si | 100 | 4.5% | Al | 20 | 10 |
| Example 9 | 96.0% | Si | 100 | 4.0% | Ti | 18 | 45 |
| Example 10 | 96.5% | Si | 100 | 3.5% | Al | 7 | 5 |
| Example 11 | 97.0% | Si | 100 | 3.0% | Ti | 14 | 12 |
| Example 12 | 97.5% | Si | 100 | 2.5% | Ti | 20 | 12 |
| Example 13 | 98.0% | Si | 100 | 2.0% | Ti | 14 | 5 |
| Example 14 | 98.5% | Si | 100 | 1.5% | Al | 66 | 30 |
| Example 15 | 99.0% | Si | 100 | 1.0% | Ti | 90 | 32 |
| Comparative | 80.0% | Si | 100 | 20.0% | Ti | 200 | 80 |
| Example 1 | | | | | | | |
| Comparative | 75.0% | Si | 100 | 25.0% | Al | 180 | 75 |
| Example 2 | | | | | | | |
| Comparative | 99.7% | Si | 100 | 0.3% | Ti | 4 | 2 |
| Example 3 | | | | | | | |
| Comparative | 99.8% | Si | 100 | 0.2% | Al | 4 | 3 |
| Example4 | | | | | | | |
| Comparative | 95.0% | SiO | 5000 | 5.0% | Ti | 10 | 10 |
| Example 5 | | | | | | | |

### Test of Properties of the Battery

### Measurement of Conductivity of the Composite Silicon-Based Negative Electrode Material

The resistivity of the composite silicon-based negative electrode material prepared in Examples 1-15 and Comparative Examples 1-5 of the present application was measured by using a powder resistivity tester, wherein 1 g of a sample (the composite silicon-based negative electrode material) was weighed and placed in a mold of the tester, and the tester was operated to start to apply a pressure, and a conductivity value was recorded when the pressure reached 200 MPa. The measurement results are shown in Table 4 below.

### Determination of the Delithiation Capacity of the Composite Silicon-Based Negative Electrode Material

The delithiation capacity of the lithium-ion secondary batteries produced by Examples 1 to 15 and Comparative Examples 1 to 5 described above was measured as follows. At an ambient temperature of 23° C., a current of 0.1 C was used to delithiate the battery, lithium was intercalated to 0 V, this process was stopped at 0.01 C and was allowed to stand for 10 min, and then delithiation was performed to 1.5 V, at which point the corresponding capacity was the delithiated capacity. The measurement results are shown in Table 4 below.

### Determination of the First-Time Efficiency

The first-time discharge capacity of the lithium-ion secondary batteries produced by Examples 1-15 and Comparative Examples 1-5 of the present application described above was measured as follows. Charging was performed under conditions of an ambient temperature of 23° C., a charging voltage of 4.35 V, a charging current of 0.5 mA, and a charging time of 10 hours, then discharging was performed under conditions of a discharging current of 2.5 mA and a terminal voltage of 3.0 V, and the first-time discharge capacity (discharge capacity at the first cycle) was measured.

The first-time efficiency of the lithium ion secondary battery produced by each example and each comparative example was calculated by the following calculation formula:

$$First - time efficiency = first discharge capacity / first charge capacity$$

The first-time charge capacity is 0.5 mA×10 h=5 mAh. The experimental results are shown in Table 4.

### Determination of the Cycle Retention Rate

The cycle retention rate of the lithium-ion secondary battery produced by each of the described examples and comparative examples was measured as follows. First, charge was performed under conditions of an ambient temperature of 23° C., a charge voltage of 4.35 V, a charge current of 0.5 mA, and a charge time of 10 hours, then discharge was performed under conditions of a discharge current of 2.5 mA and a terminal voltage of 3.0 V, and the initial discharge capacity (discharge capacity at the first cycle) was measured. Next, repeat charge and discharge were performed under charge conditions of an ambient temperature of 23° C., a charge voltage of 4.35 V, a charge current of 0.5 mA and a charge time of 10 hours, and discharge conditions of a discharge current of 2.5 mA and a terminal voltage of 3.0 V. Subsequently, the discharge capacity at the 100th cycle was measured. Subsequently, the cycle retention rate (%) after 100 cycles was calculated based on the following formula using the discharge capacity at the first cycle and the discharge capacity at the 100th cycle.

$$Cycle retention rate after 100 cycles [ \% ] = ( discharge capacity at the 100 th \text{} cycle / discharge capacity at the first cycle ) \times 100$$

The experimental results are shown in Table 4.

TABLE 4

| | | Delithiation | First-time | cycle |
|---|---|---|---|---|
| | Conductivity, | capacity, | coulombic | retention |
| | S/cm | mAh/g | efficiency | rate |
| Example 1 | 18.3 | 2068 | 73.2% | 82.5% |
| Example 2 | 15 | 1700 | 74% | 78% |
| Example 3 | 6.5 | 1470 | 83.5% | 95.3% |
| Example 4 | 2.4 | 1500 | 81.6% | 90.0% |
| Example 5 | 2.1 | 2609 | 62.6% | 63.5% |
| Example 6 | 3.1 | 2653 | 65.1% | 66.3% |
| Example 7 | 7.1 | 3096 | 74.3% | 74.9% |
| Example 8 | 4.3 | 2843 | 70.4% | 68.5% |
| Example 9 | 7.4 | 3150 | 75.6% | 81.5% |
| Example 10 | 2.3 | 2637 | 63.4% | 70.1% |
| Example 11 | 3.7 | 2781 | 68.8% | 63.9% |
| Example 12 | 4.5 | 2886 | 71.9% | 70.5% |
| Example 13 | 3.5 | 2688 | 66.3% | 64.2% |
| Example 14 | 9.3 | 2657 | 74.3% | 75.2% |
| Example 15 | 11.8 | 2426 | 73.8% | 76.9% |
| Comparative | 17.7 | 1800 | 72.4% | 72.8% |
| Example 1 | | | | |
| Comparative | 28 | 1350 | 61.5% | 60.0% |
| Example 2 | | | | |
| Comparative | 0.3 | 2545 | 62.4% | 45.3% |
| Example 3 | | | | |
| Comparative | 0.4 | 2538 | 61.2% | 45.7% |
| Example 4 | | | | |
| Comparative | 0.8 | 1220 | 69.5% | 63.5% |
| Example 5 | | | | |

It can be determined from the experimental results above that the examples above of the present application achieve the following technical effects.

The composite silicon-based negative electrode materials of the present application all exhibit excellent conductivity, up to even unexpected 23.5 S/cm. In terms of the delithiation capacity, Example 9 of the present application achieved about three times as compared to the battery of Comparative Example 5 not employing the composite silicon-based negative electrode material of the present application. In addition, the experimental results of the examples of the present application also show significant improvement compared with Comparative Example 5, and the cycle retention rate reaches 70% or more.

The description above is only the preferred examples of the present application, and is not intended to limit the present application. For a person skilled in the art, the present application may have various modifications and variations. Any modifications, equivalent replacements, improvements and the like made within the spirit and principle of the present application shall belong to the scope of protection of the present application.

1. A composite silicon-based negative electrode material, comprising:
a silicon-based material core layer;
a metal material shell layer coating the silicon-based material core layer,
wherein the silicon-based material core layer comprises a permeation area formed by the permeation of the metal material shell layer into the silicon-based material core layer.

2. The composite silicon-based negative electrode material according to claim 1, wherein the thickness of the silicon-based material core layer is in the range of about 10 nm to about 10000 nm.

3. The composite silicon-based negative electrode material according to claim 1, wherein the thickness of the metal material shell layer is in the range of about 5 nm to about 1000 nm.

4. The composite silicon-based negative electrode material according to claim 1, wherein the thickness of the permeation area is in the range of about 5 nm to about 100 nm.

5. The composite silicon-based negative electrode material according to claim 1, wherein the silicon-based material core layer comprises elemental silicon, a silicon-oxygen compound, a silicon-carbon compound, a silicon-aluminum alloy, a silicon-titanium alloy, or any combination thereof.

6. The composite silicon-based negative electrode material according to claim 1, wherein the metal material shell layer comprises aluminum and/or titanium.

7. The composite silicon-based negative electrode material according to claim 1, wherein the amount of the silicon-based material core layer is in the range of about 85 wt % to about 99.5 wt %, and the amount of the metal material shell layer is in the range of about 0.5 wt % to about 15 wt %, based on the total weight of the composite silicon-based negative electrode material.

8. A method for preparing a composite silicon-based negative electrode material, comprising:
step S1, placing a silicon-based material precursor and a metal material precursor in a mass ratio of 0.2:1 to 20:1 in a reactor; and
step S2, maintaining the temperature at a range of about 500° C. to about 700° C. for about 10 minutes to about 2 hours in an inert atmosphere.

9. The method of claim 8, further comprising:
step S3, sieving the product obtained in step S2 so as to obtain a composite silicon-based negative electrode material with a median particle size of about 0.5 μm to about 20 μm.

10. The method of claim 8, wherein the metal material precursor comprises titanium, aluminum, a chloride of titanium, a chloride of aluminum, or any combination thereof.

11. The method of claim 8, wherein the silicon-based material precursor comprises elemental silicon, a silicon-oxygen compound, a silicon-carbon compound, a silicon-aluminum alloy, a silicon-titanium alloy, or any combination thereof.

12. The method of claim 8, wherein the reactor comprises a rotary kiln or a fluidized bed; and
preferably, the rotation speed of the fluidized bed is between about 0.5 rpm and about 20 rpm.

13. The method of claim 8, wherein the inert atmosphere comprises argon, helium, nitrogen, or any combination thereof.

14. A lithium-ion secondary battery, comprising:
a positive electrode sheet,
a negative electrode sheet, and
a separator,
wherein the negative electrode sheet comprises the composite silicon-based negative electrode material according to claim 1.
